(19) United States
(12) Patent Application Publication
(10) Pub. No.: US 2024/0429575 A1
(43) Pub. Date: Dec. 26, 2024

(54) BATTERY SAFETY MECHANISM AND BATTERY

(71) Applicant: Murata Manufacturing Co., Ltd., Nagaokakyo-shi (JP)

(72) Inventors: Hideaki YAMADA, Nagaokakyo-shi (JP); Toshifumi KAMIKIDO, Nagaokakyo-shi (JP); Takuya KIHARA, Nagaokakyo-shi (JP); Yusuke TANJI, Nagaokakyo-shi (JP)

(21) Appl. No.: 18/823,933

(22) Filed: Sep. 4, 2024

Related U.S. Application Data
(63) Continuation of application No. PCT/JP2023/007993, filed on Mar. 3, 2023.

(30) Foreign Application Priority Data
Mar. 18, 2022 (JP) 2022-043522

(51) Int. Cl. H01M 50/578; H01M 50/107; H01M 50/152; H01M 50/342

(52) U.S. Cl. CPC H01M 50/578; H01M 50/107; H01M 50/152; H01M 50/3425

(57) ABSTRACT

A safety mechanism of a battery that includes: a lid; a pressure release member in contact with the lid and constructed to be deformed when an internal pressure of the battery increases; a current shutoff member on a side opposite to the lid with respect to the pressure release member, and connected to the pressure release member so as to shut off a current flowing to the pressure release member when the internal pressure of the battery increases; and an insulating layer between the pressure release member and the current shutoff member. The pressure release member has at least one of groove open toward the current shutoff member, between a position where the pressure release member and the current shutoff member are connected to each other and the pressure release member and the lid are in contact with each other.

### CROSS REFERENCE TO RELATED APPLICATIONS

The present application is a continuation of International application No. PCT/JP2023/007993, filed Mar. 3, 2023, which claims priority to Japanese Patent Application No. 2022-043522, filed Mar. 18, 2022, the entire contents of each of which are incorporated herein by reference.

### TECHNICAL FIELD

The present disclosure relates to a battery safety mechanism and a battery.

### BACKGROUND ART

A variety of electronic devices such as a mobile phone and a personal digital assistant (PDA) are widely used, and there is a demand for downsizing, weight saving, and prolonged lifetime of the electronic devices. Therefore, as a power source, a battery, particularly a secondary battery that is small in size, lightweight, and capable of obtaining a high energy density has been developed. In addition, a secondary battery including a safety mechanism for releasing a gas generated by decomposition or the like of an electrolytic solution to an outside of the battery is known.

Patent Document 1 discloses a battery including such a safety mechanism. FIG. 10 is a view schematically illustrating a safety mechanism 200 and a configuration around the safety mechanism 200 in a battery disclosed in Patent Document 1.

As illustrated in FIG. 10, a battery safety mechanism 200 disclosed in Patent Document 1 includes a battery lid 201, a disk plate 202 that is deformed when an internal pressure of a battery increases and has a pressure release function for releasing a gas inside the battery to the outside, a current shutoff member 203 that shuts off current when the internal pressure of the battery increases, and an insulating disk holder 204 interposed between the disk plate 202 and the current shutoff member 203. The current shutoff member 203 includes a shutoff disk 203a and a sub disk 203b. The disk plate 202 has a protrusion portion 202a protruding toward the current shutoff member 203. The protrusion portion 202a is connected to the sub disk 203b through a hole 203c provided in the shutoff disk 203a. Further, the disk plate 202 is provided with a groove open toward the battery lid 201 so as to be broken when the internal pressure of the battery increases.

In the safety mechanism 200 of the battery, when the internal pressure of the battery increases, the disk plate 202 is lifted toward the battery lid 201, and the protrusion portion 202a separates from the sub disk 203b connected to a positive electrode lead 210, and thus current flowing to the disk plate 202 and the battery lid 201 is shut off. Further, it is configured such that the disk plate 202 is pushed toward the battery lid 201 and broken at a position where the groove is provided, and thus the gas generated inside the battery flows toward the battery lid 201 and is discharged to the outside through a hole provided in the battery lid 201.
Patent Document 1: WO 2018/042777

### SUMMARY OF THE DISCLOSURE

As described above, in the safety mechanism 200 described in Patent Document 1, a space 220 is provided between the disk plate 202 and the battery lid 201 in order to realize a configuration in which the disk plate 202 is lifted toward the battery lid 201 and broken when the internal pressure of the battery increases. Specifically, a center portion of the battery lid 201 has a structure protruding outward, and the disk plate 202 has a bent portion 202r bent toward the shutoff disk 203a, thereby forming the space 220 necessary for the disk plate 202 to be broken.

Here, if the disk plate 202 is broken with a smaller amount of displacement when the internal pressure of the battery increases and the disk plate 202 is pushed toward the battery lid 201, the space 220 can be reduced, so that the safety mechanism 200 can be thinned. If the safety mechanism 200 can be thinned, for example, when the size of the battery is determined, sizes of the positive electrode, the negative electrode, and the like can be increased, so that capacity can be further increased.

The present disclosure solves the above problems, and an object of the present disclosure is to provide a safety mechanism of a battery having a pressure release member that can be broken with a smaller amount of displacement when the internal pressure of the battery increases, and a battery including such a safety mechanism of the battery.

A safety mechanism of a battery of the present disclosure includes: a lid; a pressure release member in contact with the lid and constructed to be deformed when an internal pressure of the battery increases to release a gas inside the battery to an outside of the battery; a current shutoff member that on a side opposite to the lid with respect to the pressure release member, and connected to the pressure release member so as to shut off a current flowing to the pressure release member when the internal pressure of the battery increases; and an insulating layer between and connecting the pressure release member to the current shutoff member, and the pressure release member has at least one groove open toward the current shutoff member, between a position where the pressure release member and the current shutoff member are connected to each other and a position where the pressure release member and the lid are in contact with each other, in a direction perpendicular to a stacking direction of the lid, the pressure release member, the current shutoff member, and the insulating layer.

According to the safety mechanism of the battery of the present disclosure, the pressure release member has, in order to be easily deformed and broken when the internal pressure of the battery increases, at least one groove open toward the current shutoff member, between a position where the pressure release member and the current shutoff member are connected to each other and a position where the pressure release member and the lid are in contact with each other, in a direction perpendicular to a stacking direction of the lid, the pressure release member, the current shutoff member, and the insulating layer. Since the groove is open toward the current shutoff member, the pressure release member can be broken with a smaller amount of displacement when the internal pressure of the battery increases as compared with a configuration in which the groove is open toward the lid. Therefore, since a space between the lid and the pressure release member can be reduced, the safety mechanism of the battery can be thinned.

### BRIEF EXPLANATION OF THE DRAWINGS

FIG. 1 is a sectional view schematically illustrating a configuration of a battery including a safety mechanism of the battery according to an embodiment of the present disclosure.

FIG. 2 is a sectional view schematically illustrating a configuration of the safety mechanism of the battery in the embodiment of the present disclosure.

FIG. 3 is an exploded perspective view of the safety mechanism of the battery according to the embodiment of the present disclosure.

FIG. 4 is a plan view when the pressure release member is viewed from a current shutoff member side in a stacking direction.

FIG. 5 is a plan view of the pressure release member when a shape of a first groove and a second groove is an arc shape as viewed from the current shutoff member side in the stacking direction.

FIGS. 6(a) to 6(f) are views illustrating various examples of a shape of a section of the first groove when cut in a direction perpendicular to a extending direction of the first groove.

FIG. 7(a) is a view for schematically illustrating a current shutoff function of the current shutoff member, and FIG. 7(b) is a view for schematically illustrating a pressure release function of the pressure release member.

FIG. 8 is a view for illustrating a configuration of an electrode assembly.

FIG. 9 is a sectional view schematically illustrating a configuration of the safety mechanism of the battery in a case where the pressure release member has a projection and a flat plate portion, and the current shutoff member has a flat plate shape.

FIG. 10 is a sectional view schematically illustrating a safety mechanism and a configuration around the safety mechanism in a battery disclosed in Patent Document 1.

### DESCRIPTION OF THE PREFERRED EMBODIMENTS

Hereinafter, features of the present disclosure will be specifically described with reference to an embodiment of the present disclosure.

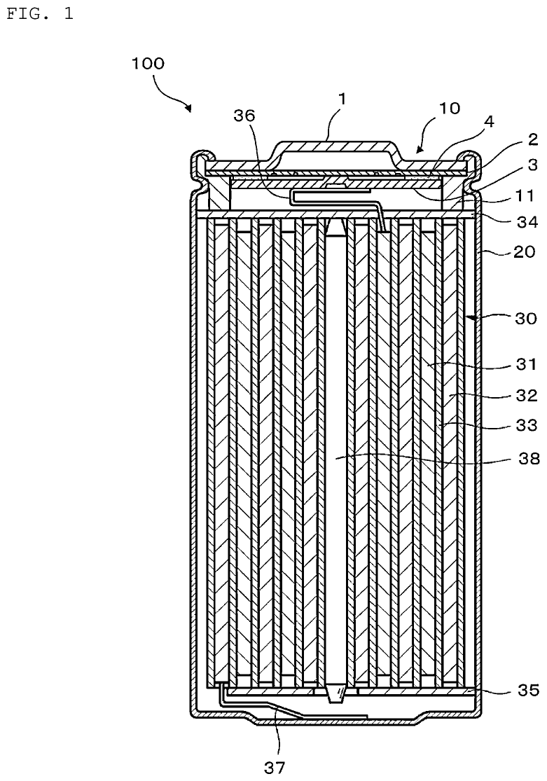

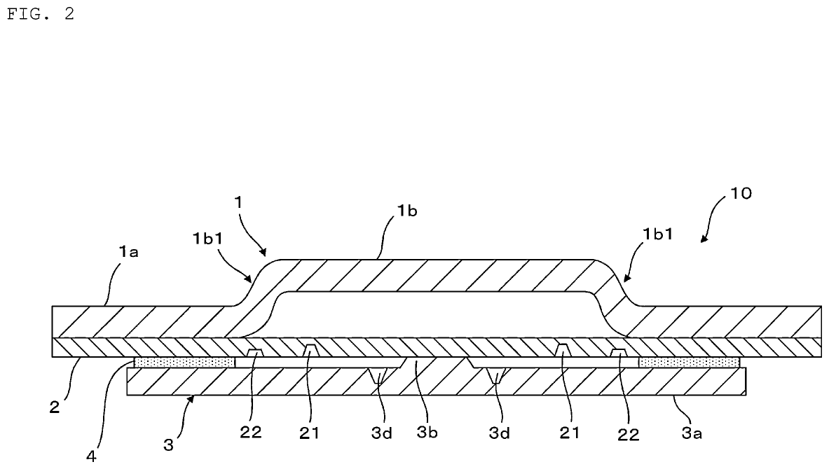

FIG. 1 is a sectional view schematically illustrating a configuration of a battery 100 including a safety mechanism 10 of the battery according to the embodiment of the present disclosure. FIG. 2 is a sectional view schematically illustrating a configuration of the safety mechanism 10 of the battery in the embodiment of the present disclosure. FIG. 3 is an exploded view of the safety mechanism 10 of the battery.

Here, the embodiment will be described assuming that the battery 100 is a cylindrical lithium ion secondary battery. However, a type of the battery 100 is not limited to a lithium ion battery, and may be another type of battery such as a manganese battery, a nickel-metal hydride battery, or a nickel-cadmium battery. Further, the battery 100 is not limited to a secondary battery and may be a primary battery. Furthermore, a shape of the battery 100 is not limited to a cylindrical shape, and may be another shape such as a square shape or a button shape.

The safety mechanism 10 of the battery includes a lid 1, a pressure release member 2, a current shutoff member 3, and an insulating layer 4.

The lid 1 is a member for sealing an opening of a battery can 20 described later. As illustrated in FIG. 2, the lid 1 has a flat plate portion la having a flat plate shape, and a protrusion portion 1b that is positioned at a center portion of the lid 1 in a mode surrounded by the flat plate portion la and protrudes to the outside of the battery 100. Since the protrusion portion 1b of the lid 1 has a shape protruding to the outside of the battery 100, the protrusion portion 1b includes a bent portion 1b1 extending from the flat plate portion 1a toward the outside of the battery 100. A portion of the protrusion portion 1b of the lid 1 other than the bent portion 1b1 has a flat plate shape similarly to the flat plate portion 1a.

A thickness of the lid 1 is, for example, 1.5 mm to 3.0 mm. In the battery 100 in the present embodiment, the lid 1 functions as a positive electrode terminal of the battery 100, and the battery can 20 functions as a negative electrode terminal. The lid 1 and the battery can 20 are insulated from each other. The lid 1 is provided with a discharge hole 1c for discharging a gas generated inside the battery 100 to the outside of the battery 100. The lid 1 includes, for example, a conductive material such as steel such as SPCC, stainless steel (SUS) such as SUS430 or SUS304, nickel (Ni), aluminum (Al), or titanium (Ti).

The pressure release member 2 is a member that is in contact with the lid 1 and is deformed when the internal pressure of the battery increases to release the gas inside the battery to the outside. As illustrated in FIG. 3, the pressure release member 2 has a flat plate shape, and has a thickness of, for example, 0.2 mm to 0.5 mm. A shape of the pressure release member 2 when viewed in a stacking direction (hereinafter, simply referred to as the stacking direction) of the lid 1, the pressure release member 2, the insulating layer 4, and the current shutoff member 3 is circular. However, the shape of the pressure release member 2 is not limited to a circular shape.

The pressure release member 2 includes, for example, a conductive material such as aluminum such as A1050, A3203, or A5052, titanium, platinum (Pt), or gold (Au). Since the pressure release member 2 includes at least one of aluminum, titanium, platinum, and gold, reaction decomposition in the lithium ion secondary battery can be prevented.

The pressure release member 2 has at least one groove open toward the current shutoff member 3, between a position where the pressure release member 2 and the current shutoff member 3 are connected to each other and a position where the pressure release member 2 and the lid 1 are in contact with each other, in a direction perpendicular to the stacking direction, so as to be deformed when the internal pressure of the battery increases. A depth of the groove is, for example, 0.1 mm to 0.2 mm. The groove may be provided such that a minimum thickness of the pressure release member 2 at a position where the groove is provided is, for example, 0.1 mm to 0.2 mm in a sectional view in the stacking direction. The groove may be preferably provided such that the minimum thickness of the pressure release member 2 at the position where the groove is provided is, for example, 0.12 mm to 0.18 mm.

As such a groove, the pressure release member 2 in the present embodiment includes a first groove 21 open toward the current shutoff member 3 and a second groove 22 open toward the current shutoff member 3 and located radially outside the first groove 21. Since each of the first groove 21 and the second groove 22 is open toward the current shutoff member 3, the pressure release member 2 can be broken with a smaller amount of displacement when the internal pressure of the battery increases as compared with a configuration in which they are open toward the lid 1.

However, only one groove open toward the current shutoff member 3 may be provided in the pressure release member 2, or three or more grooves may be provided.

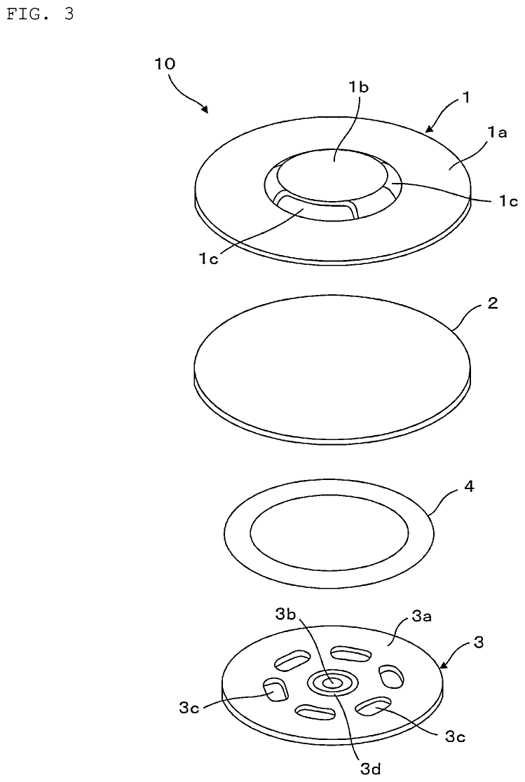

FIG. 4 is a plan view when the pressure release member 2 is viewed from the current shutoff member 3 side in the stacking direction. As illustrated in FIG. 4, in the present embodiment, shapes of the first groove 21 and the second groove 22 when viewed in the stacking direction are both circular. In addition, the first groove 21 and the second groove 22 form concentric circles.

However, the shapes of the first groove 21 and the second groove 22 when viewed in the stacking direction are not limited to circular shapes. For example, as illustrated in FIG. 5, the shapes of the first groove 21 and the second groove 22 when viewed in the stacking direction may be arc shapes. FIG. 5 illustrates an example in which three arc-shaped first grooves 21 and three arc-shaped second grooves 22 are provided, but the number is not limited to three.

Depths of the first groove 21 and the second groove 22 are different from each other. Specifically, the first groove 21 is deeper than the second groove 22. Since the first groove 21 is deeper than the second groove 22, the pressure release member 2 is broken at a position where the first groove 21 is provided when the internal pressure of the battery increases. The minimum thickness of the pressure release member 2 at the position where the first groove 21 is provided may be, for example, 0.1 mm to 0.19 mm, and the minimum thickness of the pressure release member 2 at a position where the second groove 22 is provided may be, for example, 0.11 mm to 0.2 mm. The minimum thickness of the pressure release member 2 at the position where the first groove 21 is provided may be, for example, 0.12 mm to 0.17 mm, and the minimum thickness of the pressure release member 2 at the position where the second groove 22 is provided may be, for example, 0.15 mm to 0.18 mm. For example, when the thickness of the pressure release member 2 is 0.3 mm, a depth of the first groove 21 is 0.11 mm to 0.2 mm, and preferably 0.13 mm to 0.18 mm. A depth of the second groove 22 is, for example, 0.1 mm to 0.19 mm, and preferably 0.12 mm to 0.15 mm. Note that a difference in depth between the first groove 21 and the second groove 22 is, for example, 0.01 mm to 0.1 mm, and preferably 0.01 mm to 0.06 mm.

As illustrated in FIG. 2, the second groove 22 of the pressure release member 2 is located near an inner contact end in a region where the lid 1 and the pressure release member 2 are in contact with each other. “Near an inner contact end” means a range within 1.5 mm from the inner contact end inward in a radial direction (a direction perpendicular to the stacking direction). As illustrated in FIG. 2, the pressure release member 2 is in contact with the flat plate portion la of the lid 1 and is not in contact with the bent portion 1b1. The second groove 22 of the pressure release member 2 is preferably provided at a position overlapping the bent portion 1b1 of the protrusion portion 1b of the lid 1 in the stacking direction.

Since the second groove 22 of the pressure release member 2 is located near the inner contact end in the region where the lid 1 and the pressure release member 2 are in contact with each other, the pressure release member 2 is, as described later, less likely to be deformed along the bent portion 1b1 of the lid 1 at the position where the second groove 22 is provided when the internal pressure of the battery increases. This makes it possible to suppress positional deviation and the like of the lid 1. In addition, it is possible to suppress an influence on processing variation of the lid 1. The pressure release member 2 is easily broken at the position where the first groove 21 is provided.

As illustrated in FIG. 2, in the present embodiment, a shape of a section of the first groove 21 when cut in a direction perpendicular to an extending direction of the first groove 21 is trapezoidal. Similarly, a shape of the second groove 22 when cut in the direction perpendicular to the extending direction of the second groove 22 is trapezoid. Note that in the present embodiment, since a shape of the first groove 21 when viewed in the stacking direction is circular, the direction perpendicular to the extending direction of the first groove 21 is a direction perpendicular to a tangent of the first groove 21 that is circular. The same applies to the direction perpendicular to the extending direction of the second groove 22.

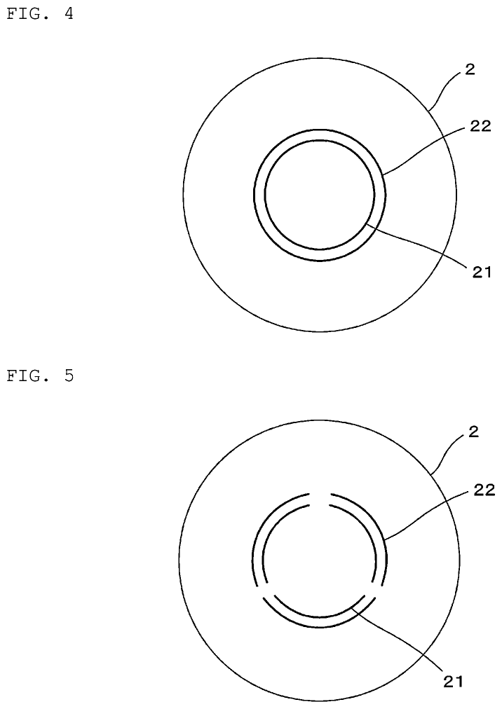

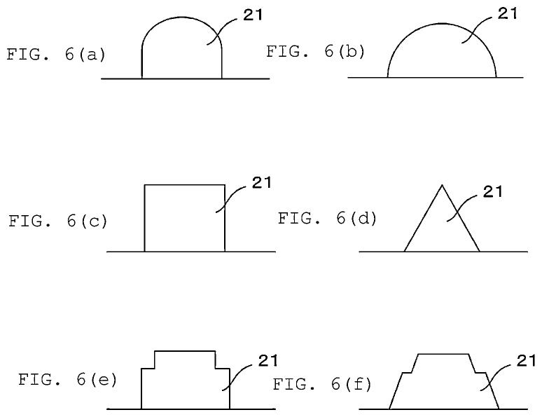

However, the shape of the section of the first groove 21 when cut in the direction perpendicular to the extending direction of the first groove 21 and the shape of the second groove 22 when cut in the direction perpendicular to the extending direction of the second groove 22 are not limited to trapezoidal. FIGS. 6(a) to 6(f) are views illustrating various examples of the shape of the section of the first groove 21 when cut in the direction perpendicular to the extending direction of the first groove 21. The shape of the section of the first groove 21 may be a semicircular shape as illustrated in FIG. 6(b), a rectangular shape as illustrated in FIG. 6(c), or a triangular shape as illustrated in FIG. 6(d). In addition, as illustrated in FIG. 6(a), the shape of the section of the first groove 21 may be rectangular with a bottom of the groove shaped like an arc. Furthermore, the shape of the section of the first groove 21 may be a shape obtained by combining two rectangles having different widths as illustrated in FIG. 6(e), or may be a shape obtained by combining two trapezoids having different base lengths as illustrated in FIG. 6(f). Similarly, a shape of a section of the second groove 22 can also be a shape illustrated in FIGS. 6(a) to 6(f). Note that the shapes of the sections of the first groove 21 and the second groove 22 may be a shape other than a shape illustrated in FIGS. 2 and 6(a) to 6(f). In addition, the shapes of the sections of the first groove 21 and the second groove 22 may be the same or different.

The current shutoff member 3 is connected to a positive electrode lead 36 led out from an electrode assembly 30 of the battery 100 described later. The current shutoff member 3 is disposed on a side opposite to the lid 1 with respect to the pressure release member 2, and connected to the pressure release member 2, and is a member for shutting off a current flowing to the pressure release member 2 when the internal pressure of the battery increases. The current shutoff member 3 has a flat plate shape as a whole. Specifically, as illustrated in FIGS. 2 and 3, the current shutoff member 3 includes a flat plate portion 3a having a flat plate shape, and a projection 3b that is located at a center portion of the current shutoff member 3 in a mode surrounded by the flat plate portion 3a, projects toward the pressure release member 2 with respect to the flat plate portion 3a, and is for connecting to the pressure release member 2.

In the present embodiment, a shape of an outer peripheral end of the current shutoff member 3 is circular when viewed in the stacking direction. Further, the shape of the projection 3b of the current shutoff member 3 is circular when viewed in the stacking direction. A thickness of the flat plate portion 3a and the projection 3b of the current shutoff member 3 is, for example, 0.25 mm to 0.5 mm. The thickness of the projection 3b is substantially the same as that of the insulating layer 4 to be described later, and is, for example, 0.05 mm to 0.4 mm. The current shutoff member 3 is not a perfect flat plate because of having the projection 3b, but since the thickness of the projection 3b is thin, the current shutoff member 3 can be regarded as a flat plate shape as a whole.

In the present embodiment, the projection 3b of the current shutoff member 3 is connected to the pressure release member 2. In the present embodiment, the projection 3b of the current shutoff member 3 is joined to the pressure release member 2.

As illustrated in FIG. 3, the flat plate portion 3a of the current shutoff member 3 may be provided with a plurality of holes 3c through which the gas generated inside the battery passes. In the present embodiment, six holes 3c are provided around the projection 3b. However, the number of the holes 3c is not limited to six, and a shape thereof is not limited to a shape illustrated in FIG. 3. The holes 3c are provided at positions not overlapping the first groove 21 and the second groove 22 of the pressure release member 2 in the stacking direction.

Note that it is also possible to have a configuration in which the hole 3c is not provided depending on a shape of the current shutoff member 3. The holes 3c may be provided at positions overlapping the first groove 21 and/or the second groove 22 of the pressure release member 2 in the stacking direction.

The current shutoff member 3 includes, for example, a conductive material such as aluminum such as A1050, A3203, or A5052, titanium, platinum, or gold. Since the current shutoff member 3 includes at least one of aluminum, titanium, platinum, and gold, the reaction decomposition in the lithium ion secondary battery can be prevented.

The current shutoff member 3 has a groove 3d open toward the pressure release member 2, between a position where the current shutoff member 3 and the pressure release member 2 are connected to each other and a position where the current shutoff member 3 and the insulating layer 4 are in contact with each other, in the direction perpendicular to the stacking direction. A depth of the groove 3d is, for example, 0.2 mm to 0.46 mm. In the present embodiment, the groove 3d is provided near the projection 3b of the current shutoff member 3 so as to surround the projection 3b. The shape of the groove 3d when viewed in the stacking direction is circular. However, the shape of the groove 3d is not limited to a circular shape, and may be another shape such as an arc shape.

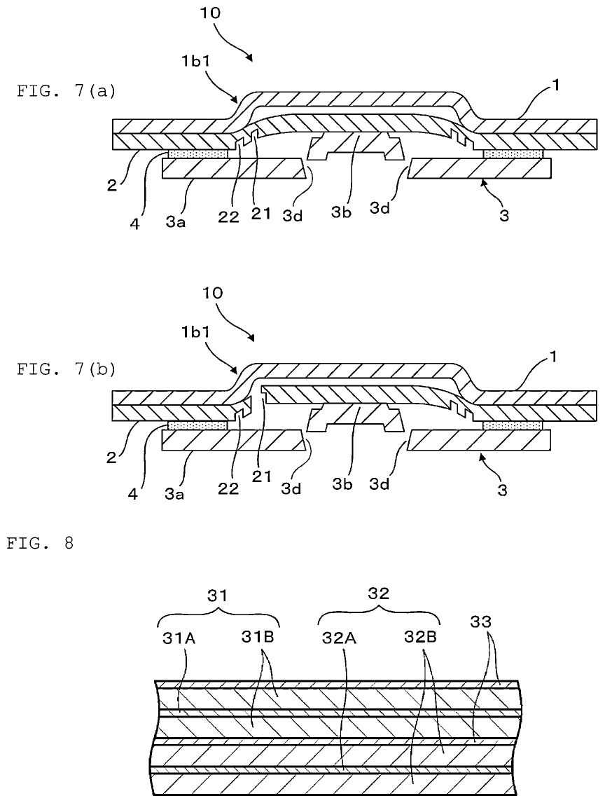

FIG. 7(a) is a view for schematically illustrating a current shutoff function of the current shutoff member 3, and FIG. 7(b) is a view for schematically illustrating a pressure release function of the pressure release member 2. When the internal pressure of the battery 100 increases due to internal short circuit of the battery 100, heating from the outside of the battery 100, or the like, as illustrated in FIG. 7(a), a portion including the projection 3b is separated from the flat plate portion 3a at a position where the groove 3d of the current shutoff member 3 is formed. Thus, since the portion including the projection 3b separated from the flat plate portion 3a is also separated from the positive electrode lead 36 (see FIG. 1), a current flowing from the positive electrode lead 36 to the pressure release member 2 via the current shutoff member 3 is shut off. Further, as illustrated in FIG. 7(a), in the pressure release member 2 connected to the projection 3b of the current shutoff member 3, a portion not in contact with the lid 1 is deformed to bulge toward the lid 1.

Further, when the internal pressure of the battery further increases due to the gas or the like generated inside the battery 100, a force of pushing the pressure release member 2 toward the lid 1 increases, and the pressure release member 2 is cut at the position where the first groove 21 is provided as illustrated in FIG. 7(b). That is, the pressure release member 2 is deformed such that a portion near the position where the second groove 22 is provided follows the bent portion 1b1 of the lid 1, and is cut at the position where the first groove 21 having a depth deeper than that of the second groove 22 is provided. Thus, the gas generated inside the battery 100 flows toward the lid 1, and is discharged to the outside through a hole (not illustrated) provided in the lid 1.

As described above, since each of the first groove 21 and the second groove 22 of the pressure release member 2 is open toward the current shutoff member 3, the pressure release member 2 is broken with a smaller amount of displacement when the internal pressure of the battery increases as compared with the configuration in which they are open toward the lid 1. This has been confirmed by the inventors through experiments. Therefore, since a space between the lid 1 and the pressure release member 2 can be reduced, the pressure release member 2 can have a flat plate shape. Thus, the safety mechanism 10 of the battery can be thinned.

The insulating layer 4 having insulating properties is interposed between the pressure release member 2 and the current shutoff member 3. More specifically, the insulating layer 4 is disposed between the pressure release member 2 and the current shutoff member 3 and radially outside the second groove 22 of the pressure release member 2. Since the insulating layer 4 is interposed between the pressure release member 2 and the current shutoff member 3, the pressure release member 2 connected to the positive electrode lead 36 and the current shutoff member 3 can be insulated from each other when the current shutoff function of the current shutoff member 3 is performed (see FIG. 7(a)).

In the present embodiment, the insulating layer 4 is an adhesive layer that bonds the pressure release member 2 and the current shutoff member 3. In this case, the insulating layer 4 includes any one of a thermosetting resin, a thermoplastic resin, a UV curable resin, and an anaerobic adhesive. Specifically, as the insulating layer 4, an epoxy resin-based adhesive containing an epoxy resin as a main component, an acrylic resin-based adhesive containing an acrylic resin as a main component, a fluororesin-based adhesive containing a fluororesin as a main component, a silicone resin-based adhesive containing a silicone resin as a main component, a synthetic resin-based adhesive containing a synthetic resin as a main component, a urethane resin-based adhesive containing a urethane resin as a main component, or the like can be used.

When the thermosetting resin is used as the insulating layer 4, a glass transition temperature Tg is preferably 100° C. or higher, and more preferably 170° C. or higher. Examples of the thermosetting resin having a glass transition temperature Tg of 100° C. or higher include epoxy resins. Further, when the thermoplastic resin is used as the insulating layer 4, a melting point Tm is preferably 200° C. or higher, and more preferably 270° C. or higher. When the insulating layer 4 includes the thermosetting resin having a glass transition temperature Tg of 100° C. or higher or the thermoplastic resin having a melting point Tm of 200° C. or higher, the insulating layer 4 having insulating property continues to be interposed between the pressure release member 2 and the current shutoff member 3 no matter when a temperature of the battery reaches a high temperature of several hundred ° C. Therefore, when the current shutoff function of the current shutoff member 3 is performed (see FIG. 7(a)), an insulating state between the pressure release member 2 connected to the positive electrode lead 36 and the current shutoff member 3 can be maintained, and occurrence of short circuit can be prevented.

In the present embodiment, the insulating layer 4 has an annular shape as illustrated in FIG. 3 when viewed in the stacking direction. However, the shape of the insulating layer 4 when viewed in the stacking direction is not limited to the annular shape. The insulating layer 4 can be formed using, for example, a dispenser. A thickness of the insulating layer 4 is, for example, 0.05 mm to 0.4 mm. Further, an area of the insulating layer 4 is, for example, 0.6 mm² to 100 mm².

However, the insulating layer 4 is not limited to an adhesive layer including an adhesive, and may include another material such as a molded resin.

### Method for Manufacturing Safety Mechanism

An example of a method for manufacturing the safety mechanism 10 described above will be described.

First, the lid 1 and the pressure release member 2 are joined together. Specifically, the flat plate portion 1a of the lid 1 and the pressure release member 2 are joined together. A joining method is arbitrary, and joining can be achieved, for example, by welding such as ultrasonic welding.

Subsequently, the adhesive is applied to at least one of a surface of the pressure release member 2 on the side opposite to the lid 1 and a surface of the current shutoff member 3 on the projection 3b side, and the pressure release member 2 and the current shutoff member 3 are bonded together with the applied adhesive interposed therebetween. As described above, it is possible to use, as the adhesive, the epoxy resin-based adhesive, the acrylic resin-based adhesive, the fluororesin-based adhesive, the silicone resin-based adhesive, the synthetic resin-based adhesive, the urethane resin-based adhesive, or the like. A thickness of the adhesive to be applied is, for example, 0.1 mm to 0.4 mm, and an area to be applied is, for example, 0.6 mm² to 100 mm². Thus, the insulating layer 4 is formed between the pressure release member 2 and the current shutoff member 3.

Finally, the projection 3b of the current shutoff member 3 is connected to the pressure release member 2. A connection method is arbitrary, and connection can be achieved, for example, by welding such as laser welding.

Note that the pressure release member 2 and the current shutoff member 3 may be first bonded to each other with the adhesive interposed therebetween, then the projection 3b of the current shutoff member 3 and the pressure release member 2 may be bonded to each other, and finally the lid 1 and the pressure release member 2 may be bonded to each other.

### Battery

Next, an example of a structure of the battery 100 including the safety mechanism 10 of the present disclosure will be described. The battery 100 includes the safety mechanism 10, the battery can 20, and the electrode assembly 30.

In the present embodiment, the battery can 20 has a hollow cylindrical shape with one end opened, and houses the electrode assembly 30. The battery can 20 includes, for example, iron (Fe) plated with nickel. Nickel, stainless steel, aluminum, titanium, or the like may be used as a material of the battery can 20. A surface of the battery can 20 may be plated with, for example, nickel or the like in order to prevent corrosion due to an electrochemical non-aqueous electrolytic solution associated with charging and discharging of a non-aqueous electrolyte battery.

The safety mechanism 10 is attached to a release end portion of the battery can 20 so that the lid 1 faces outward. Specifically, the safety mechanism 10 is attached to the battery can 20 by being crimped with a gasket 11 for an insulating seal interposed therebetween. An inside of the battery can 20 is thus hermitically sealed.

The electrode assembly 30 including a positive electrode 31, a negative electrode 32, and a separator 33 provided between the positive electrode 31 and the negative electrode 32 is housed inside the battery can 20. In the present embodiment, the electrode assembly 30 is a wound electrode assembly in which a pair of strip-shaped positive electrode 31 and strip-shaped negative electrode 32 are wound around a center pin 38 in a state where the positive electrode 31 and the negative electrode 32 are stacked with the separator 33 interposed therebetween. However, the electrode assembly 30 is not limited to the wound electrode assembly. In the battery 100 of the present disclosure, the electrode assembly 30 may have any configuration.

The positive electrode lead 36 is connected to the positive electrode 31, and a negative electrode lead 37 is connected to the negative electrode 32. As described above, the positive electrode lead 36 is connected to the current shutoff member 3 of the safety mechanism 10 of the battery, and is electrically connected to the lid 1 with the pressure release member 2 interposed therebetween. The negative electrode lead 37 is welded to the battery can 20, and electrically connected to the battery can 20.

An electrolytic solution as a liquid electrolyte is injected into the battery can 20. The positive electrode 31, the negative electrode 32, and the separator 33 are impregnated with the electrolytic solution. Further, a pair of insulating plates 34 and 35 are arranged perpendicular to a winding peripheral surface so as to sandwich the electrode assembly 30.

Hereinafter, the positive electrode 31, the negative electrode 32, the separator 33, and the electrolytic solution constituting the electrode assembly 30 will be sequentially described with reference to FIG. 8.

### Positive Electrode

The positive electrode 31 has, for example, a structure in which a positive electrode active material layer 31B is provided on both surfaces of a positive electrode current collector 31A. However, the positive electrode active material layer 31B may be provided only on one surface of the positive electrode current collector 31A. The positive electrode current collector 31A includes, for example, a metal foil such as an aluminum foil, a nickel foil, or a stainless-steel foil. The positive electrode active material layer 31B contains, for example, a positive electrode active material capable of occluding and releasing lithium which is an electrode reactant. The positive electrode active material layer 31B may further contain an additive, if necessary. For example, at least one of a conductive agent and a binder can be used as the additive.

As a positive electrode material capable of occluding and releasing lithium, for example, a lithium-containing compound such as a lithium oxide, a lithium phosphorus oxide, a lithium sulfide, or an interlayer compound containing lithium is suitable, and two or more kinds thereof may be mixed and used. In order to increase energy density, a lithium-containing compound containing lithium, a transition metal element, and oxygen (O) is preferably used. Examples of such a lithium-containing compound include a lithium composite oxide having a layered rock salt-type structure represented by formula (A), and a lithium composite phosphate having an olivine type structure represented by formula (B). The lithium-containing compound more preferably contains at least one selected from the group consisting of cobalt (Co), nickel, manganese (Mn), and iron as the transition metal element. Examples of such a lithium-containing compound include a lithium composite oxide having a layered rock salt-type structure represented by formula (C), formula (D), or formula (E), a lithium composite oxide having a spinel type structure represented by formula (F), and a lithium composite phosphate having an olivine type structure represented by formula (G), and specific examples thereof include LiNi_{0.50}Co_{0.20}Mn_{0.30}O₂, LiₐCoO₂ (a≈1), Li_{b}NiO₂ (b≈1), Li_{c1}Ni_{c2}Co_{1-c2}O₂ (c1˜1, 0<c2<1), Li_{d}Mn₂O₄ (d≈1), and LiₑFePO₄ (e≈1).

LiₚNi_{(1-q-r)}Mn_{q}M1ᵣO_{(2-y)}X_{z} (A)

In the formula (A), M1 represents at least one of elements selected from Group 2 to Group 15 excluding nickel and manganese. X represents at least one among Group 16elements and Group 17 elements other than oxygen. p, q, r, y, and z are values within ranges of 0≤p≤1.5, 0≤q≤1.0, 0≤r≤1.0, −0.10≤y≤0.20, and 0≤z≤0.2.

LiₐM2_{b}PO₄ (B)

In the formula (B), M2 represents at least one of elements selected from Group 2 to Group 15. a and b are values within ranges of 0≤a≤2.0 and 0.5≤b ≤2.0.

Li_{f}Mn_{(1-g-h)}Ni_{g}M3ₕO₍₂₋ⱼ₎Fₖ (C)

In the formula (C), M3 represents at least one from the group consisting of cobalt, magnesium (Mg), aluminum, boron (B), titanium (Ti), vanadium (V), chromium (Cr), iron, copper (Cu), zinc (Zn), zirconium (Zr), molybdenum (Mo), tin (Sn), calcium (Ca), strontium (Sr), and tungsten (W). f, g, h, j, and k are values within ranges of 0.8≤f≤1.2, 0<g<0.5, 0≤h≤0.5, g+h<1, −0.1≤j≤0.2, and 0≤k≤0.1. Note that composition of lithium varies depending on a state of charge and discharge, and a value of f represents a value in a fully discharged state.

LiₘNi₍₁₋ₙ₎M4ₙO₍₂₋ₚ₎F_{q} (D)

In the formula (D), M4 represents at least one selected from the group consisting of cobalt, manganese, magnesium, aluminum, boron, titanium, vanadium, chromium, iron, copper, zinc, molybdenum, tin, calcium, strontium, and tungsten. m, n, p, and q are values within ranges of 0.8≤m≤1.2, 0.005≤n≤0.5, −0.1≤p≤0.2, and 0≤q≤0.1. Note that the composition of lithium varies depending on the state of charge and discharge, and a value of m represents a value in the fully discharged state.

LiᵣCo₍₁₋ₛ₎M5ₛO₍₂₋ₜ₎Fᵤ (E)

In the formula (E), M5 represents at least one selected from the group consisting of nickel, manganese, magnesium, aluminum, boron, titanium, vanadium, chromium, iron, copper, zinc, molybdenum, tin, calcium, strontium, and tungsten. r, s, t, and u are values within ranges of 0.8≤r≤1.2, 0≤s<0.5, −0.1≤t≤0.2, and 0≤u≤0.1. Note that the composition of lithium varies depending on the state of charge and discharge, and a value of r represents a value in the fully discharged state.

LiᵥMn_{2-w}M6_{w}OₓF_{y} (F)

In the formula (F), M6 represents at least one selected from the group consisting of cobalt, nickel, magnesium, aluminum, boron, titanium, vanadium, chromium, iron, copper, zinc, molybdenum, tin, calcium, strontium, and tungsten. v, w, x, and y are values within ranges of 0.9≤v≤1.1, 0≤w≤0.6, 3.7≤x≤4.1, and 0≤y≤0.1. Note that the composition of lithium varies depending on the state of charge and discharge, and a value of v represents a value in the fully discharged state.

Li_{z}M7PO₄ (G)

In the formula (G), M7 represents at least one selected from the group consisting of cobalt, manganese, iron, nickel, magnesium, aluminum, boron, titanium, vanadium, niobium (Nb), copper, zinc, molybdenum, calcium, strontium, tungsten, and zirconium. z is a value within a range of 0.9≤z≤1.1. Note that the composition of lithium varies depending on the state of charge and discharge, and a value of z represents a value in the fully discharged state.

In addition to these compounds, examples of the positive electrode material capable of occluding and releasing lithium include inorganic compounds not containing lithium, such as MnO₂, V₂O₅, V₆O₁₃, NiS, and MOS.

The positive electrode material capable of occluding and releasing lithium may be a material other than those mentioned above. Further, two or more of the positive electrode materials exemplified above may be mixed in arbitrary combination.

As the binder, for example, at least one selected from resin materials such as polyvinylidene fluoride (PVdF), polytetrafluoroethylene (PTFE), polyacrylonitrile (PAN), styrene butadiene rubber (SBR), and carboxymethyl cellulose (CMC), copolymers mainly containing these resin materials, and the like can be used.

Examples of the conductive agent include carbon materials such as graphite, carbon black, and Ketjen black, and one or more of them can be used in combination. Further, in addition to the carbon materials, it is also possible to use conductive materials such as metal materials or conductive polymer materials as the conductive agent.

### Negative Electrode

The negative electrode 32 has, for example, a structure in which a negative electrode active material layer 32B is provided on both surfaces of a negative electrode current collector 32A. However, the negative electrode active material layer 32B may be provided only on one surface of the negative electrode current collector 32A. The negative electrode current collector 32A includes, for example, a metal foil such as a copper foil, a nickel foil, or a stainless-steel foil.

The negative electrode active material layer 32B contains one or two or more negative electrode active materials capable of occluding and releasing lithium. The negative electrode active material layer 32B may further contain an additive such as a binder and a conductive agent, if necessary.

Note that in the battery 100 which is the non-aqueous electrolyte battery, it is preferable that an electrochemical equivalent of the negative electrode 32 or the negative electrode active material is larger than that of the positive electrode 31, and theoretically, lithium metal is not deposited on the negative electrode 32 during charging.

Examples of the negative electrode active material include carbon materials such as non-graphitizable carbon, graphitizable carbon, graphite, pyrolytic carbons, cokes, glassy carbons, organic polymer compound fired bodies, carbon fibers, and activated carbon. Examples of the cokes include pitch coke, needle coke, and petroleum coke. The organic polymer compound fired body refers to a carbonized product obtained by firing a polymer material such as a phenol resin or a furan resin at an appropriate temperature, and some are classified as non-graphitizable carbon or graphitizable carbon. These carbon materials are preferable because a change in crystal structure generated during charge and discharge is very small, a high charge and discharge capacity can be obtained, and good cycle characteristics can be obtained. In particular, graphite is preferable because it has a large electrochemical equivalent and a high energy density can be obtained. Non-graphitizable carbon is preferable because excellent cycle characteristics can be obtained. Further, those having a low charge and discharge potential, specifically, those having a charge and discharge potential close to that of lithium metal are preferable because a high energy density of the battery 100 can be easily obtained.

Examples of other negative electrode active materials capable of increasing the capacity include materials containing at least one of metal elements and metalloid elements as a constituent element (for example, an alloy, a compound, or a mixture). This is because the high energy density can be obtained by using such a material. In particular, when such a material is used together with a carbon material, the high energy density can be obtained and excellent cycle characteristics can be obtained, which is more preferable. Note that the alloy includes an alloy containing one or more metal elements and one or more metalloid elements in addition to an alloy containing two or more metal elements. The material of the negative electrode active material may contain a nonmetallic element. A structure thereof includes a solid solution, a eutectic (eutectic mixture), an intermetallic compound, or a mixture in which two or more of them coexist.

Examples of such a negative electrode active material include a metal element or a metalloid element capable of forming an alloy with lithium. Specific examples thereof include magnesium, boron, aluminum, titanium, gallium (Ga), indium (In), silicon (Si), germanium (Ge), tin, lead (Pb), bismuth (Bi), cadmium (Cd), silver (Ag), zinc, hafnium (Hf), zirconium, yttrium (Y), palladium (Pd), and platinum. These elements may be crystalline or amorphous.

The negative electrode active material preferably contains a metal element or metalloid element of Group 4B in the short periodic table as a constituent element, and more preferably contains at least one of silicon and tin as the constituent element. This is because silicon and tin have a great ability to occlude and release lithium and the high energy density can be obtained. Examples of such a negative electrode active material include a simple substance, an alloy, or a compound of silicon, a simple substance, an alloy, or a compound of tin, and a material having one or two or more phases thereof at least as a part of the material.

Examples of second constituent elements other than silicon constituting the alloy of silicon include those containing at least one of the group consisting of tin, nickel, copper, iron, cobalt, manganese, zinc, indium, silver, titanium, germanium, bismuth, antimony (Sb), and chromium. Examples of the second constituent elements other than tin constituting the alloy of tin include those containing at least one of the group consisting of silicon, nickel, copper, iron, cobalt, manganese, zinc, indium, silver, titanium, germanium, bismuth, antimony, and chromium.

Examples of the compound of tin or the compound of silicon include those containing oxygen or carbon. These compounds may include the second constituent element described above.

Above all, a SnCoC-containing material containing cobalt, tin, and carbon as the constituent elements, having carbon content of 9.9 mass % to 29.7 masse, and having a proportion of cobalt to a total of tin and cobalt of 30 mass % to 70 mass % is preferable as a Sn-based negative electrode active material. This is because the high energy density can be obtained in the above composition range and excellent cycle characteristics can be obtained.

This SnCoC-containing material may further contain another constituent element, if necessary. The other constituent element is preferably, for example, silicon, iron, nickel, chromium, indium, niobium, germanium, titanium, molybdenum, aluminum, phosphorus (P), gallium, or bismuth, and two or more of the above elements may be contained. This is because the capacity or the cycle characteristics can be further improved by containing the above elements as the other constituent elements.

Note that the SnCoC-containing material described above has a phase containing tin, cobalt, and carbon, and this phase preferably has a structure having a low crystallinity or being amorphous. Further, in the SnCoC-containing material, at least a part of carbon which is the constituent element is preferably bonded to a metal element or a metalloid element which is another constituent element. It is considered that deterioration of the cycle characteristics is caused by aggregation or crystallization of tin or the like, but it is because such aggregation or crystallization can be suppressed by bonding carbon to another element.

Examples of a measurement method for examining a bonding state of elements include X-ray photoelectron spectroscopy (XPS). In the XPS, in a case of graphite, a peak of 1 s orbit of carbon (C1s) appears at 284.5 eV in an apparatus energy-calibrated so that a peak of 4 f orbit of a gold atom (Au4f) is obtained at 84.0 eV. Further, in a case of surface contaminated carbon, the peak appears at 284.8 eV. In contrast, when a charge density of carbon element is high, for example, when carbon is bonded to the metal element or the metalloid element, the peak of C1s appears in a region lower than 284.5 eV. That is, when a peak of a combined wave of C1s obtained for the SnCoC-containing material appears in the region lower than 284.5 eV, at least a part of carbon contained in the SnCoC-containing material is bonded to the metal element or the metalloid element which is another constituent element.

Note that in XPS measurement, for example, the peak of C1s is used to correct an energy axis of a spectrum. In general, since the surface contaminated carbon is present on the surface, the peak of C1s of the surface contaminated carbon is set to 284.8 eV, which is used as an energy reference. In the XPS measurement, since a waveform of the peak of C1s is obtained as a form including a peak of the surface contaminated carbon and a peak of carbon in the SnCoC-containing material, the peak of the surface contaminated carbon and the peak of the carbon in the SnCoC-containing material are separated by, for example, analysis using commercially available software. In waveform analysis, a position of a main peak present on a lowest binding energy side is set as the energy reference (284.8 eV).

Examples of other negative electrode active materials include metal oxides or polymer compounds capable of occluding and releasing lithium. Examples of the metal oxides include lithium titanium oxide containing titanium and lithium, such as lithium titanate (Li₄Ti₅O₁₂), iron oxide, ruthenium oxide, and molybdenum oxide. Examples of the polymer compounds include polyacetylene, polyaniline, and polypyrrole.

As the binder, at least one selected from, for example, resin materials such as polyvinylidene fluoride, polytetrafluoroethylene, polyacrylonitrile, styrene butadiene rubber, and carboxymethylcellulose, and a copolymer including the resin materials as a main component is used. As the conductive agent, similar carbon materials to those of the positive electrode active material layer 31B and the like can be used.

### Separator

The separator 33 separates the positive electrode 31 and the negative electrode 32, and allows lithium ions to pass therethrough while preventing short circuit of current due to contact between both electrodes. The separator 33 includes, for example, a porous film made of a resin such as polytetrafluoroethylene, polypropylene, or polyethylene. The separator 33 may have a structure in which the above-described two or more kinds of porous films are laminated. Above all, the porous film made of polyolefin is preferable because of having an excellent effect of preventing short circuit and allowing improvement in safety of the battery 100 by a shutdown effect. In particular, polyethylene is preferable as a material constituting the separator 33 because polyethylene can obtain the shutdown effect within a range of 100°° C. to 160° C. and is also excellent in electrochemical stability. In addition, as a material of the separator 33, a material obtained by copolymerizing or blending a resin having chemical stability with polyethylene or polypropylene can be used. The porous film may have a structure of three or more layers in which a polypropylene layer, a polyethylene layer, and a polypropylene layer are sequentially laminated.

Further, the separator 33 may be provided with a resin layer on one side or both sides of the porous film as a substrate. The resin layer is a porous matrix resin layer carrying an inorganic substance. With such a structure, oxidation resistance can be obtained to suppress deterioration of the separator 33. As a matrix resin, for example, polyvinylidene fluoride, hexafluoropropylene (HFP), polytetrafluoroethylene, or the like, or a copolymer thereof can be used.

Examples of the inorganic substance include a metal, a semiconductor, or an oxide or nitride thereof. In that case, examples of the metal include aluminum and titanium, and examples of the semiconductor include silicon and boron. As the inorganic substance, an inorganic substance having substantially no conductivity and a large heat capacity is preferable. This is because a large heat capacity is useful as a heat sink at the time of current heat generation, and thermal runaway of the battery 100 can be further suppressed. Examples of such inorganic substances include oxides or nitrides such as alumina (Al₂O₃), boehmite (alumina monohydrate), talc, boron nitride (BN), aluminum nitride (AlN), titanium dioxide (TiO₂), and silicon oxide (SiOₓ).

A particle size of the inorganic substance is preferably in a range of 1 nm to 10 μm. When the particle size of the inorganic substance is smaller than 1 nm, it is difficult to obtain the inorganic substance, and no matter when the inorganic substance can be obtained, it is not suitable in terms of cost. When the particle size of the inorganic substance is more than 10 μm, a distance between the electrodes is large, a filling amount of the active material cannot be sufficiently obtained in a limited space, and battery capacity decreases.

The resin layer of the separator 33 can be formed, for example, by applying a slurry containing a matrix resin, a solvent, and an inorganic substance onto the substrate (porous film), passing the slurry through a good solvent bath of a poor solvent of the matrix resin and the solvent to cause phase separation, and then drying the slurry.

A piercing strength of the separator 33 is preferably in a range of 100 gf to 1000 gf. The piercing strength of the separator 33 is more preferably in a range of 100 gf to 480 gf. This is because when the piercing strength is too low, short circuit may occur, and when it is too high, ion conductivity will decrease.

An air permeability of the separator 33 is preferably in a range of 30 sec/100 cc to 1000 sec/100 cc. The air permeability of the separator 33 is more preferably in a range of 30 sec/100 cc to 680 sec/100 cc. This is because when the air permeability of the separator 33 is too low, short circuit may occur, and when it is too high, the ion conductivity will decrease.

Note that the inorganic substance described above may be contained in the porous film as the substrate.

### Electrolytic Solution

The separator 33 is impregnated with an electrolytic solution which is a liquid electrolyte. The electrolytic solution contains a solvent and an electrolyte salt dissolved in the solvent. The electrolytic solution may include a known additive to improve characteristics of the battery 100.

As the solvent, cyclic carbonic acid esters such as an ethylene carbonate and a propylene carbonate can be used, and it is preferable to use one of ethylene carbonate and propylene carbonate, particularly a mixture of both. This is because the cycle characteristics can be improved in this case.

Further, as the solvent, in addition to the cyclic carbonic acid esters described above, a chain carbonic acid ester such as diethyl carbonate, dimethyl carbonate, ethyl methyl carbonate, or methyl propyl carbonate is preferably mixed and used. This is because high ion conductivity can be obtained in this case.

Further, it is preferable that the solvent further contains 2,4-difluoroanisole or vinylene carbonate. This is because 2,4-difluoroanisole can improve the discharge capacity and vinylene carbonate can improve the cycle characteristics. Therefore, it is more preferable to use a mixture of 2,4-difluoroanisole and vinylene carbonate because the discharge capacity and the cycle characteristics can be improved.

In addition, examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropylnitrile, N,N-dimethylformamide, N-methylpyrrolidinone, N-methyloxazolidinone, N,N-dimethylimidazolidinone, nitromethane, nitroethane, sulfolane, dimethyl sulfoxide, and trimethyl phosphate.

Note that a compound obtained by substituting at least some of hydrogen atoms of non-aqueous solvents with fluorine may be preferable because reversibility of an electrode reaction may be improved depending on the type of electrodes to be combined.

Examples of the electrolyte salt include a lithium salt. The lithium salt may be used alone or in combination of two or more kinds thereof. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bisoxalate borate, and LiBr. Above all, LiPF₆ is preferable because the high ion conductivity can be obtained and the cycle characteristics can be improved.

### Operation of Battery

In the battery 100 having the above-described configuration, when charging is performed, for example, lithium ions are released from the positive electrode active material layer 31B and occluded in the negative electrode active material layer 32B via the electrolytic solution. Further, when discharging is performed, for example, lithium ions are released from the negative electrode active material layer 32B and occluded in the positive electrode active material layer 31B via the electrolytic solution.

### Method for manufacturing battery

An example of a method for manufacturing the battery 100 described above will be described below.

First, the positive electrode material capable of lithium doping and dedoping, the conductive agent, and the binder are mixed to prepare a positive electrode mixture, and the positive electrode mixture is dispersed in a mixed solvent to obtain a positive electrode mixture slurry. Subsequently, the positive electrode mixture slurry is applied to the positive electrode current collector 31A, dried, and then subjected to compression molding to prepare the positive electrode 31. Thereafter, the positive electrode lead 36 is connected to the positive electrode current collector 31A by ultrasonic welding, spot welding, or the like.

Further, a negative electrode material capable of lithium doping and dedoping and a binder are mixed to prepare a negative electrode mixture, and the negative electrode mixture is dispersed in the mixed solvent to obtain a negative electrode mixture slurry. Subsequently, the negative electrode mixture slurry is applied to the negative electrode current collector 32A, dried, and then subjected to compression molding to prepare the negative electrode 32. Thereafter, the negative electrode lead 37 is connected to the negative electrode current collector 32A by ultrasonic welding, spot welding, or the like.

Subsequently, the positive electrode 31 and the negative electrode 32 are wound many times in a state of being laminated with the separator 33 interposed therebetween, to prepare the electrode assembly 30. Thereafter, the electrode assembly 30 is sandwiched between the pair of insulating plates 34 and 35, and housed in the battery can 20. Further, the positive electrode lead 36 is connected to the current shutoff member 3 of the safety mechanism 10, and the negative electrode lead 37 is connected to the battery can 20.

Subsequently, the electrolytic solution is prepared by dissolving the electrolyte salt in the solvent. Thereafter, the electrolytic solution is injected into the battery can 20 to be impregnated into the separator 33. Subsequently, the safety mechanism 10 is attached to a release end of the battery can 20 by being crimped with the gasket 11 interposed therebetween.

The battery 100 is completed by the method described above. Note that a resin ring washer may be attached to the lid 1, or the entire battery 100 may be covered with a resin tube.

The present disclosure is not limited to the above embodiment, and various applications and modifications can be made within the scope of the present disclosure.

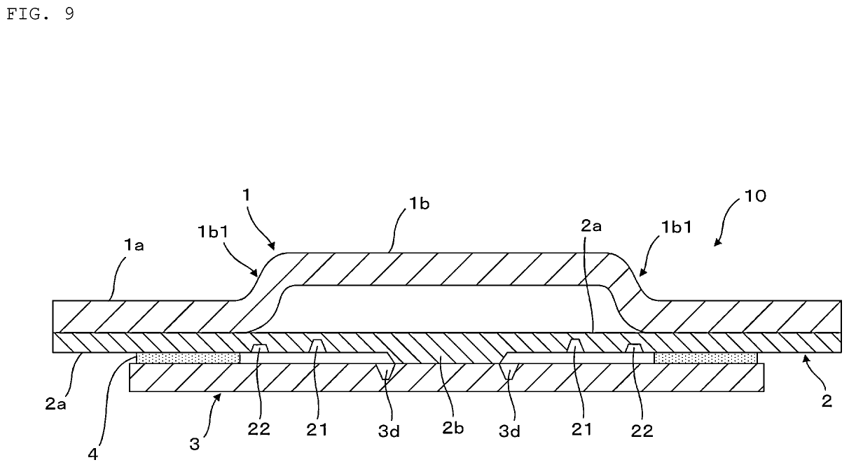

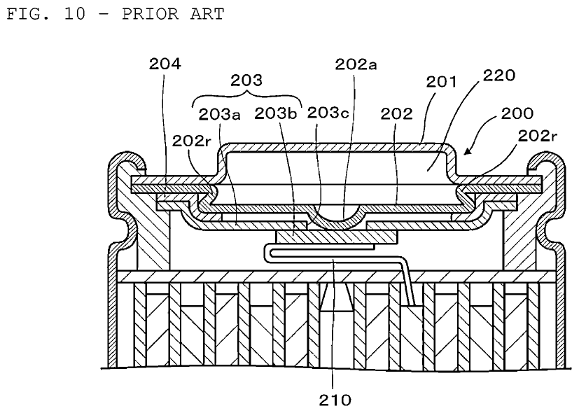

For example, in the battery 100 according to the embodiment described above, the current shutoff member 3 has the projection 3b for connecting to the pressure release member 2 and the flat plate portion 3a having a flat plate shape, and the pressure release member 2 has a flat plate shape. However, as illustrated in FIG. 9, it may be configured such that the pressure release member 2 includes a projection 2b for connecting to the current shutoff member 3 and a flat plate portion 2a having a flat plate shape, and the current shutoff member 3 has a flat plate shape. In any case, since both the pressure release member 2 and the current shutoff member 3 have a thin, flat or substantially flat shape, the battery safety mechanism 10 of the battery can be thinned. Thus, for example, when the size of the battery 100 is determined, sizes of the positive electrode 31, the negative electrode 32, and the like can be increased, so that the capacity of the battery 100 can be further increased.

Further, in the battery 100 according to the embodiment described above, the pressure release member 2 has a flat plate shape, but may have a portion bent toward the current shutoff member 3 as in the disk plate of the battery described in Patent Document 1. Similarly, the flat plate portion 3a of the current shutoff member 3, which is a portion other than the projection 3b, has a flat plate shape, but may have a portion bent toward the electrode assembly as in the shutoff disk of the battery described in Patent Document 1.

### DESCRIPTION OF REFERENCE SYMBOLS

1: Lid
1a: Flat plate portion of lid
1b: Protrusion portion of lid
1c: Discharge hole of lid
2: Pressure release member
2a: Flat plate portion of pressure release member
2b: Projection of pressure release member
3: Current shutoff member
3a: Flat plate portion of current shutoff member
3b: Projection of current shutoff member
3c: Hole
3d: Groove of current shutoff member
4: Insulating layer
10: Safety mechanism of battery
11: Gasket
20: Battery can
21: First groove
22: Second groove
30: Electrode assembly
31: Positive electrode
32: Negative electrode
33: Separator
34, 35: Insulating plate
36: Positive electrode lead
37: Negative electrode lead
38: Center pin
100: Battery

1. A safety mechanism of a battery, the safety mechanism comprising:
a lid;
a pressure release member in contact with the lid and constructed to be deformed when an internal pressure of the battery increases so as to release a gas inside the battery to an outside of the battery;
a current shutoff member on a side opposite to the lid with respect to the pressure release member, and connected to the pressure release member so as to shut off a current flowing to the pressure release member when the internal pressure of the battery increases; and
an insulating layer interposed between and connecting the pressure release member to the current shutoff member,
wherein the pressure release member has at least one groove open toward the current shutoff member, between a position where the pressure release member and the current shutoff member are connected to each other and a position where the pressure release member and the lid are in contact with each other, in a direction perpendicular to a stacking direction of the lid, the pressure release member, the current shutoff member, and the insulating layer.

2. The safety mechanism of the battery according to claim 1, wherein a minimum thickness of the pressure release member at a position of the at least one groove is 0.1 mm to 0.2 mm in a sectional view in the stacking direction.

3. The safety mechanism of the battery according to claim 1, wherein a depth of the at least one groove is 0.1 mm to 0.2 mm.

4. The safety mechanism of the battery according to claim 1, wherein the at least one groove is a plurality of grooves.

5. The safety mechanism of the battery according to claim 4, wherein the plurality of grooves include:
a first groove; and
a second groove located radially outside the first groove, and wherein
a first depth of the first groove and a second depth of the second groove are different from each other.

6. The safety mechanism of the battery according to claim 5, wherein the first depth of the first groove is larger than the second depth of the second groove.

7. The safety mechanism of the battery according to claim 6, wherein
in a sectional view in a stacking direction, a minimum thickness of the pressure release member at a position of the first groove is 0.1 mm to 0.19 mm, and
a minimum thickness of the pressure release member at a position of the second groove is 0.11 mm to 0.2 mm.

8. The safety mechanism of the battery according to claim 6, wherein
the first depth of the first groove is 0.11 mm to 0.2 mm, and
the second depth of the second groove is 0.1 mm to 0.19 mm.

9. The safety mechanism of the battery according to claim 5, wherein the second groove is located near an inner contact end in a region where the lid and the pressure release member are in contact with each other.

10. The safety mechanism of the battery according to claim 1, wherein a shape of the at least one groove when viewed in the stacking direction is a circular shape or an arc shape.

11. The safety mechanism of the battery according to claim 1, wherein a shape of a section of the at least one groove in a direction perpendicular to an extending direction of the at least one groove is trapezoidal.

12. The safety mechanism of the battery according to claim 1, wherein a shape of a section of the at least one groove in a direction perpendicular to an extending direction of the at least one groove is semicircular, rectangular, or triangular.

13. The safety mechanism of the battery according to claim 1, wherein
the current shutoff member includes a projection that connects to the pressure release member and a flat plate portion having a flat plate shape, and
the pressure release member has a flat plate shape.

14. The safety mechanism of the battery according to claim 1, wherein
the pressure release member includes a projection that connects to the current shutoff member and a flat plate portion having a flat plate shape, and
the current shutoff member has a flat plate shape.

15. The safety mechanism of the battery according to claim 1, wherein the current shutoff member has a groove open toward the pressure release member, between a position where the current shutoff member and the pressure release member are connected to each other and a position where the current shutoff member and the insulating layer are in contact with each other, in a direction perpendicular to the stacking direction.

16. The safety mechanism of the battery according to claim 1, wherein a material of the pressure release member includes at least one of aluminum, titanium, platinum, and gold.

17. The safety mechanism of the battery according to claim 1, wherein a material of the current shutoff member includes at least one of aluminum, titanium, platinum, and gold.

18. The safety mechanism of the battery according to claim 1, wherein the insulating layer is an adhesive layer that bonds the pressure release member to the current shutoff member.

19. A battery comprising:
an electrode assembly including a positive electrode, a negative electrode, and a separator between the positive electrode and the negative electrode;
a battery can that houses the electrode assembly; and
the safety mechanism of the battery according to claim 1 attached to the battery can.

20. The battery according to claim 19, wherein the battery can is a cylindrical battery can of a lithium ion secondary battery.
